(19) United States
(12) Patent Application Publication
(10) Pub. No.: US 2024/0185090 A1
(43) Pub. Date: Jun. 6, 2024

(54) ASSESSMENT OF ARTIFICIAL INTELLIGENCE ERRORS USING MACHINE LEARNING

(71) Applicant: Capital One Services, LLC, McLean, VA (US)

(72) Inventors: Galen RAFFERTY, Mahomet, IL (US); Samuel SHARPE, Cambridge, MA (US); Brian BARR, Schenectady, NY (US); Jeremy GOODSITT, Champaign, IL (US); Austin WALTERS, Savoy, IL (US); Kenny BEAN, Herndon, VA (US)

(21) Appl. No.: 18/061,685

(22) Filed: Dec. 5, 2022

(51) Int. Cl. G06N 5/022

(52) U.S. Cl. CPC G06N 5/022

(57) ABSTRACT

In some implementations, a device may identify a use of artificial intelligence by an entity to reach a decision in connection with a user. The device may determine, using a machine learning model, that the decision in connection with the user is erroneous. The machine learning model may be trained to determine whether the decision is erroneous based on first information relating to the use of artificial intelligence by the entity and second information relating to one or more historical decisions in connection with the user or one or more other users. The device may provide a notification indicating that the decision in connection with the user is erroneous.

### BACKGROUND

Artificial intelligence describes different ways that a machine interacts with an environment. Through advanced, human-like intelligence (e.g., provided by software and hardware), an artificial intelligence system may perceive an environment and take actions that maximize a chance of achieving goals. Machine learning is an approach, or a subset, of artificial intelligence, with an emphasis on learning rather than just computer programming. A machine learning system may utilize complex models to analyze a massive amount of data, recognize patterns among the data, and generate an output (e.g., a prediction, a classification, or the like) without requiring a human to program specific instructions.

### SUMMARY

Some implementations described herein relate to a system for assessment of artificial intelligence errors using machine learning. The system may include one or more memories and one or more processors communicatively coupled to the one or more memories. The one or more processors may be configured to receive a notification indicating a complaint that a decision in connection with a user is erroneous, the decision being reached by a use of artificial intelligence by an entity. The one or more processors may be configured to determine, using at least one machine learning model, whether the decision in connection with the user is erroneous and an amount of a reparation for the user that is to be issued by the entity. The at least one machine learning model may be trained to determine whether the decision is erroneous and the amount of the reparation based on first information relating to the use of artificial intelligence by the entity and second information relating to one or more historical decisions in connection with the user or one or more other users. The one or more processors may be configured to transmit, in response to the notification, an indication of whether the reparation for the user is to be issued by the entity due to the decision. The one or more processors may be configured to cause judgment information, indicating whether the decision in connection with the user is erroneous and the amount of the reparation, to be added to a blockchain.

Some implementations described herein relate to a method of assessment of artificial intelligence errors using machine learning. The method may include identifying, by a device, a use of artificial intelligence by an entity to reach a decision in connection with a user. The method may include determining, by the device and using a machine learning model, that the decision in connection with the user is erroneous. The machine learning model may be trained to determine whether the decision is erroneous based on first information relating to the use of artificial intelligence by the entity and second information relating to one or more historical decisions in connection with the user or one or more other users. The method may include providing, by the device, a notification indicating that the decision in connection with the user is erroneous.

Some implementations described herein relate to a non-transitory computer-readable medium that stores a set of instructions for assessment of artificial intelligence errors using machine learning. The set of instructions, when executed by one or more processors of a device, may cause the device to identify a use of artificial intelligence by an entity to reach a decision in connection with a user. The set of instructions, when executed by one or more processors of the device, may cause the device to determine, using a machine learning model, that the decision in connection with the user is erroneous. The machine learning model may be trained to determine whether the decision is erroneous based on first information relating to the use of artificial intelligence by the entity and second information relating to one or more historical decisions in connection with the user or one or more other users. The set of instructions, when executed by one or more processors of the device, may cause the device to cause complaint information, indicating a complaint that the decision in connection with the user is erroneous, to be added to a blockchain.

### BRIEF DESCRIPTION OF THE DRAWINGS

FIGS. 1A-1F are diagrams of an example associated with assessment of artificial intelligence errors using machine learning, in accordance with some embodiments of the present disclosure.

FIG. 2 is a diagram illustrating an example of a blockchain and use thereof, in accordance with some embodiments of the present disclosure.

FIG. 3 is a diagram illustrating an example of training and using a machine learning model in connection with assessment of artificial intelligence errors, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of a device associated with assessment of artificial intelligence errors using machine learning, in accordance with some embodiments of the present disclosure.

FIG. 6 is a flowchart of an example process associated with assessment of artificial intelligence errors using machine learning, in accordance with some embodiments of the present disclosure.

FIG. 7 is a flowchart of an example process associated with assessment of artificial intelligence errors using machine learning, in accordance with some embodiments of the present disclosure.

### DETAILED DESCRIPTION

The following detailed description of example implementations refers to the accompanying drawings. The same reference numbers in different drawings may identify the same or similar elements.

Various systems may employ artificial intelligence (AI) in reaching decisions (e.g., recommendations, classifications, predictions, or the like) for users. For example, a system may use AI to determine a recommendation for a user, to perform facial recognition of a user, to determine an action for an autonomous vehicle of a user, or to determine whether to approve a user's application for a credit card or loan, among numerous other examples. Sometimes, a decision reached using AI may be erroneous (e.g., the decision may be different from a decision that would be reached by a human that is neutral and fully informed), which may be because the programming for the AI has flawed algorithms and/or because information relating to a user and/or an environment, that is used by the AI to reach a decision, is lacking or misleading. In such cases, a system of reparations (which may be referred to as “digital reparations”) may include recording complaints of erroneous AI decisions and/or recording adjudications of the complaints as records on a blockchain.

However, in general, detecting that an AI decision is erroneous (as opposed to merely unfavorable to a user or undesired by a user) may be technically difficult. This is because AI decision-making may commonly use a “black box” approach, where an input to, and an output from, an AI system are known, but the logic used by the system to achieve the output may be unknown. Accordingly, significant computing resources (e.g., processor resources, memory resources, or the like) may be expended in an attempt to understand or reverse engineer the logic used by the AI system in order to determine whether a decision is erroneous.

Some implementations described herein may enable a user device to assess whether a decision, in connection with a user, reached by an entity using AI is erroneous. In some implementations, the user device may use a machine learning model to determine whether the decision is erroneous. The machine learning model may be trained to determine whether the decision is erroneous based on first information relating to the use of AI by the entity and/or second information relating to historical decisions, reached using AI, relating to the user and/or other users. The user device may identify the historical decisions by processing unstructured data (e.g., social media posts) using natural language processing (NLP), computer vision techniques, or the like. Based on determining that the decision is erroneous, the user device may cause complaint information, indicating a complaint that the decision in connection with the user is erroneous, to be added to a blockchain. In some implementations, based on determining that the decision is erroneous, the user device may provide a notification (e.g., on the user device) indicating that the decision is erroneous, may transmit a report (e.g., to the reparation system and/or to another system that tracks AI decisions) on the decision (e.g., indicating factors that lead the user device to determine that the decision is erroneous), may transmit information (e.g., to a device of the entity) indicating characteristics associated with the user (e.g., a location of the user, demographic information for the user, financial information for the user, or the like) that may be used by the AI to reach an improved decision, and/or may transmit a request (e.g., to the device of the entity) to reach another decision using the characteristics.

In some implementations, a reparation system configured for adjudicating complaints may also, or alternatively, assess whether the decision is erroneous. The reparation system may use at least one machine learning model to determine whether the decision is erroneous and/or an amount of a reparation that should be issued to the user by the entity if the decision is erroneous. The machine learning model(s) may be trained to determine whether the decision is erroneous and/or the amount of the reparation in a similar manner as described above. Moreover, the machine learning model(s) may be trained to determine the amount of the reparation based on historical reparation data in the blockchain. Based on determining whether the decision is erroneous (e.g., which may be a different determination than the determination made by the user device) and/or the amount of the reparation, the reparation system may cause judgment information, indicating whether the decision is erroneous and/or the amount of the reparation, to be added to the blockchain. In some implementations, based on determining that the decision is erroneous, the reparation system may provide a notification (e.g., to the user device) indicating that the decision is erroneous, may transmit a report (e.g., to the user device, to a device of the entity, and/or to another system that tracks AI decisions) on the decision (e.g., indicating factors that led the reparation system to determine that the decision is erroneous), may transmit information (e.g., to a device of the entity) identifying historical decisions relating to the user and/or other similar users that demonstrate that the decision is erroneous, and/or may transmit a request (e.g., to the device of the entity) to reach another decision for the user (e.g., based on the report and/or the information identifying the historical decisions).

In this way, the machine learning models used by the user device and the reparation system may facilitate efficient detection, correction, and/or prevention of erroneous AI decisions. Accordingly, computing resources that may have otherwise been used attempting to understand or reverse engineer the logic used by AI in reaching a decision may be conserved. In addition, the AI may be improved using information associated with erroneous AI decisions detected by the user device and/or the reparation system, thereby conserving computing resources that may have otherwise been used inefficiently by the AI to reach an erroneous decision. Moreover, complaint information and judgment information recorded to the blockchain provide data that can be used by the machine learning models to facilitate detection of erroneous AI decisions. Thus, techniques described herein may continually improve an ability of the machine learning models to accurately detect erroneous AI decisions.

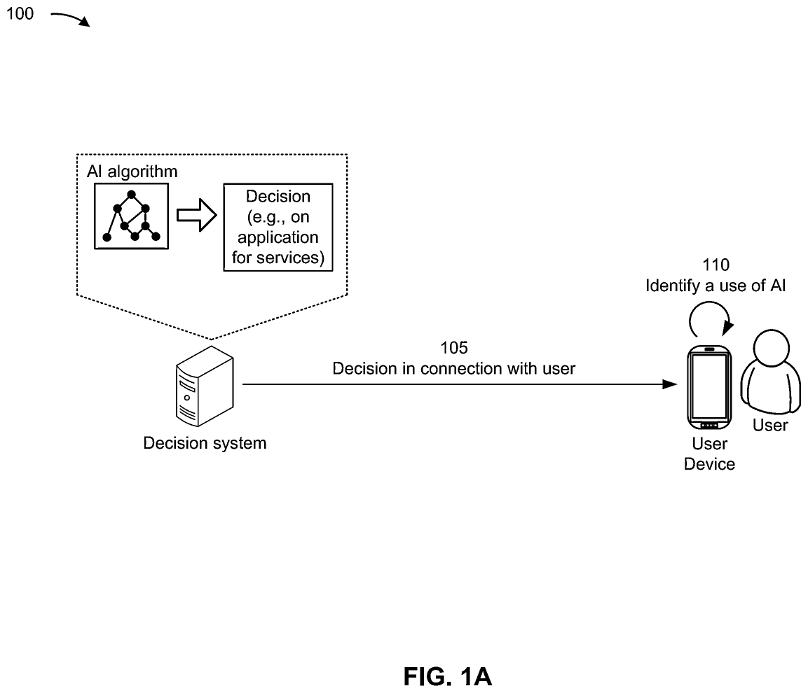

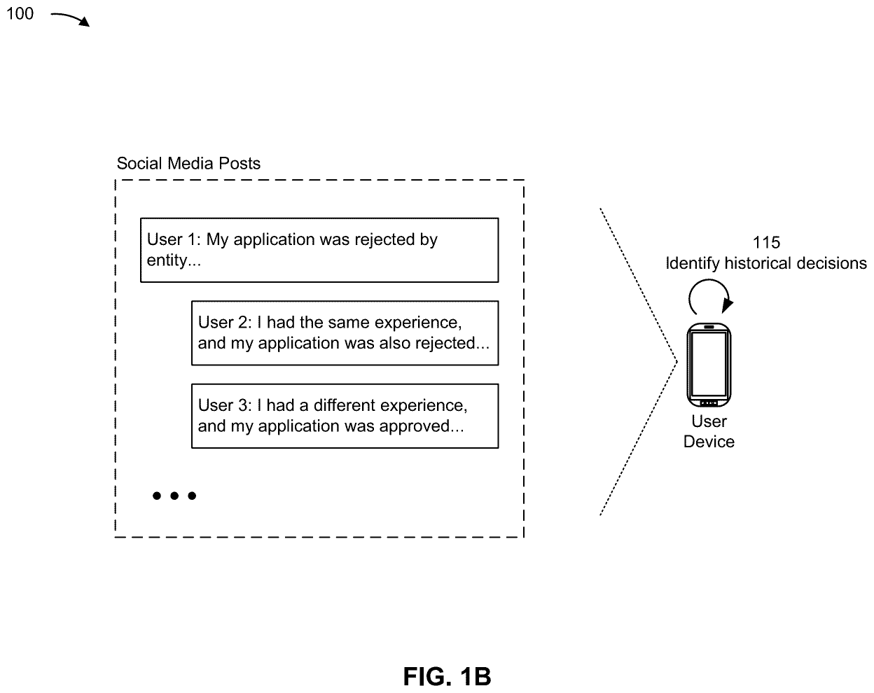

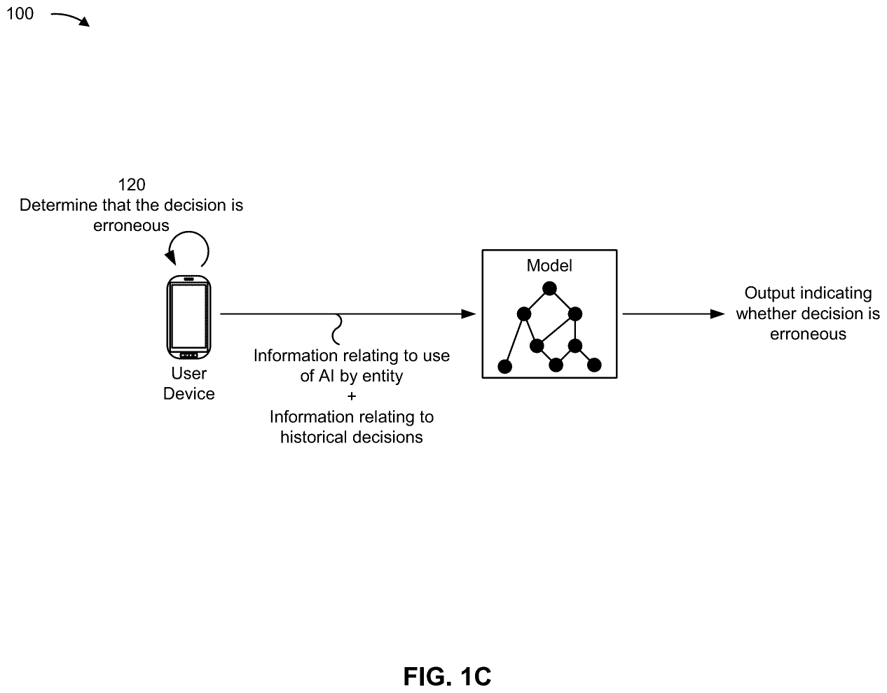

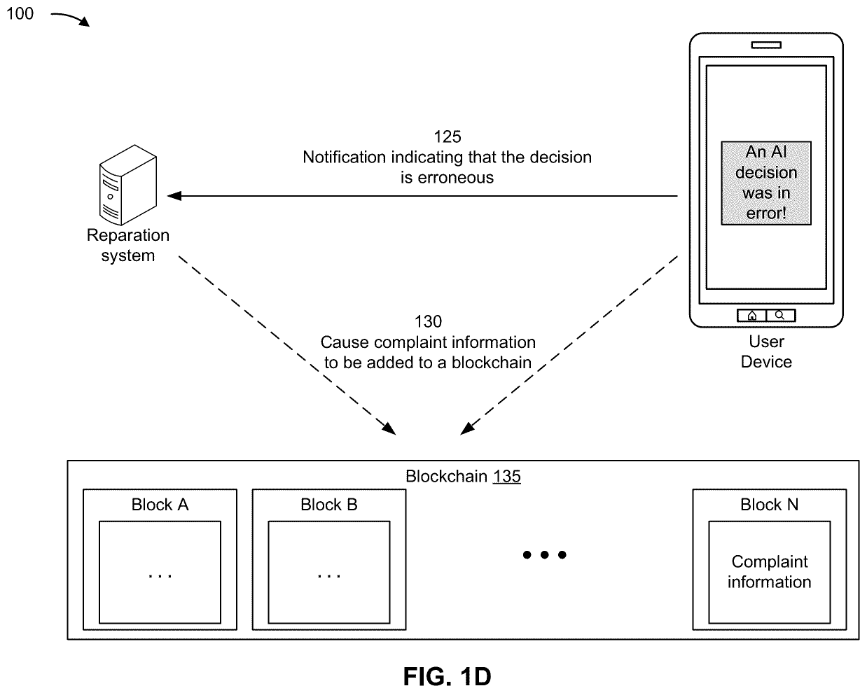

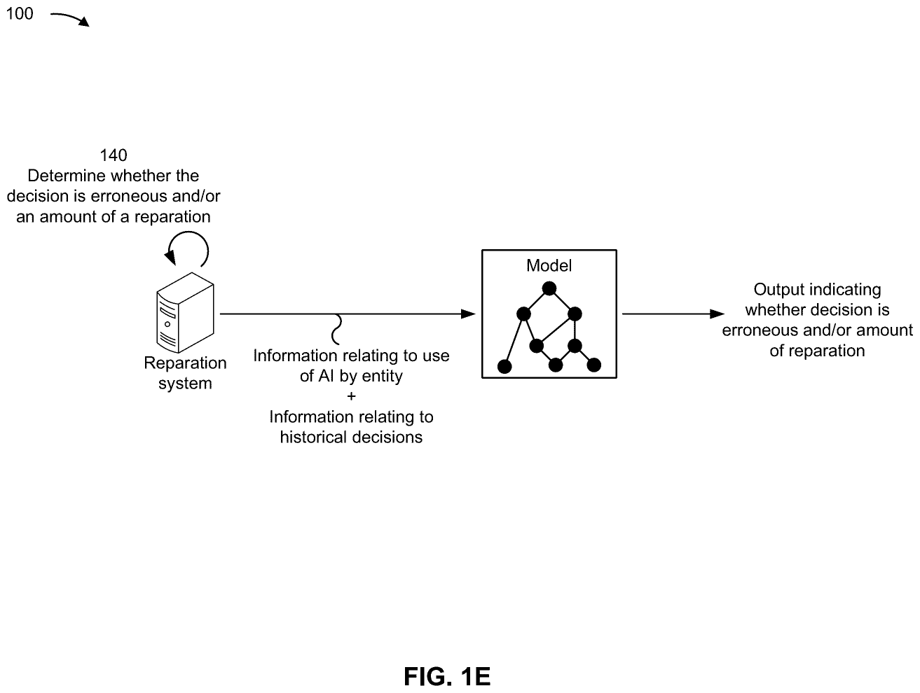

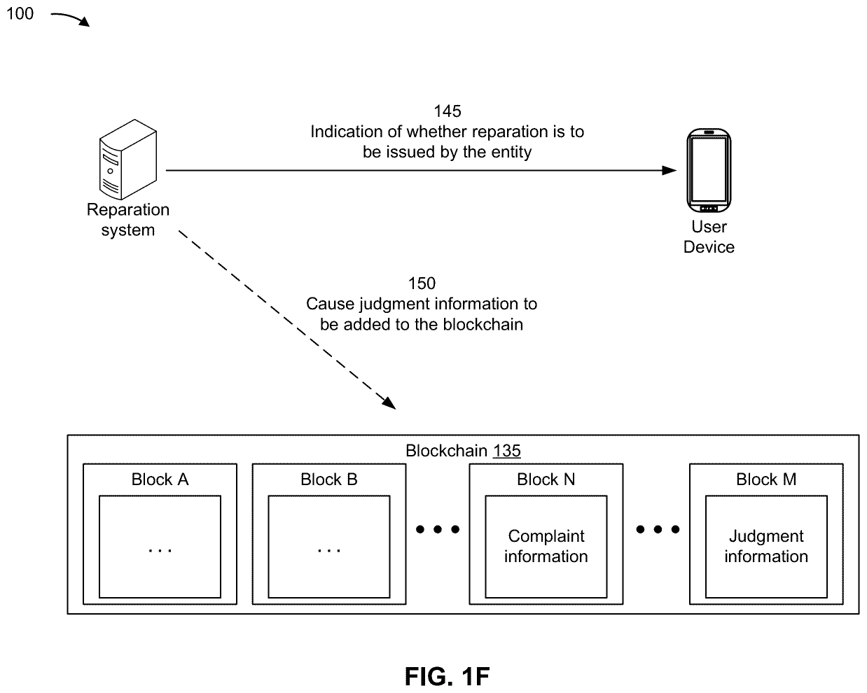

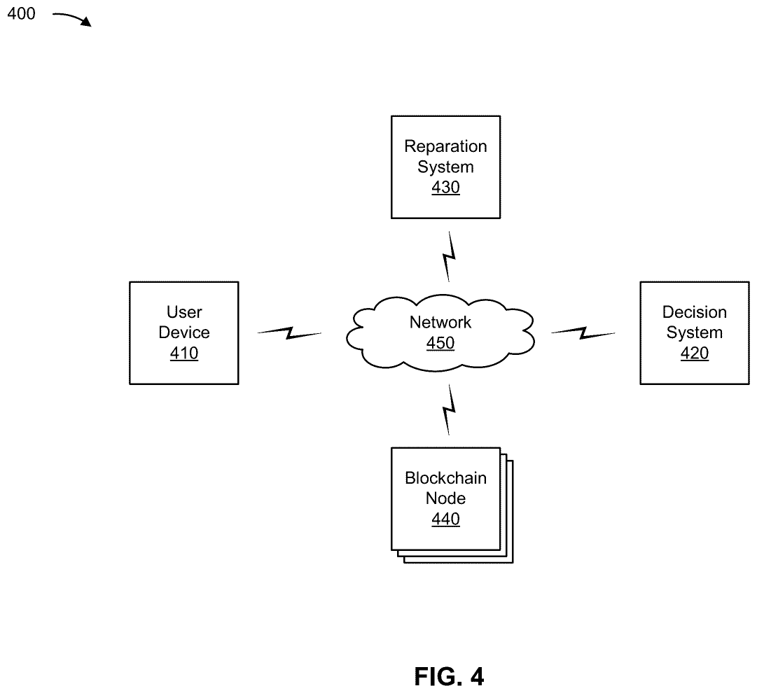

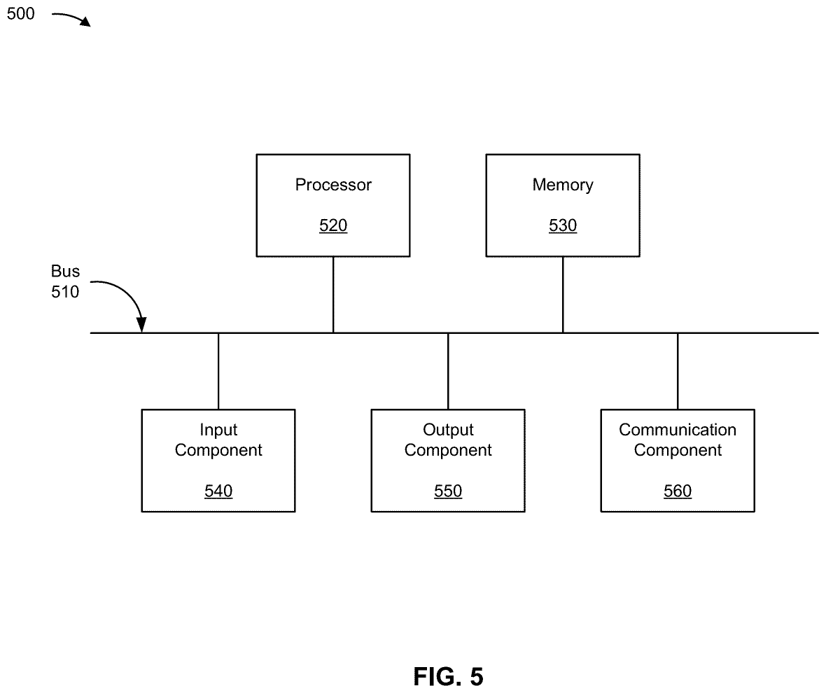

FIGS. 1A-1F are diagrams of an example 100 associated with assessment of AI errors using machine learning. As shown in FIGS. 1A-1F, example 100 includes a user device, a decision system, and a reparation system. These devices are described in more detail in connection with FIGS. 4 and 5. In some implementations, the user device may be associated with a user that may encounter the use of AI by an entity in reaching a decision for the user. For example, the user may encounter the use of AI in connection with an application for services. As an example, the user may apply for services, such as loan services, line of credit services, and/or mortgage services, among other examples, from the entity. In other examples, the user may encounter the use of AI in connection with a recommendation of an item, a recommendation of an action based on facial recognition, or the like.

In some implementations, the decision system may be associated with the entity, and the decision system may be configured to use AI in reaching a decision for the user. For example, the decision system may use AI (e.g., a machine learning model) to determine whether to approve or reject the application for services. In other examples, the decision system may use AI to determine the recommendation of the item, determine the recommendation of the action, or the like. In some implementations, the reparation system may be associated with an individual or an entity (e.g., a neutral third party) that is responsible for adjudicating complaints that a decision reached using AI is erroneous. For example, the reparation system may be used to determine whether to award a reparation for an AI decision that is erroneous.

As shown in FIG. 1A, and by reference number 105, the decision system may transmit, and the user device may receive, information indicating a decision that has been reached in connection with the user. For example, the decision may indicate that the user's application for services has been rejected. In some other examples, the decision may recommend an action based on facial recognition performed on the user or another individual encountered by the user, may recommend an item for the user to purchase, may indicate a user-specific price for goods or services, may indicate traveling directions for the user, or the like. The decision may be in response to a request from the user or the user device.

The decision system may determine the decision using an AI technique. For example, the decision system may determine the decision using one or more machine learning models. This use of AI by the decision system in reaching the decision may not be apparent to the user.

As shown by reference number 110, the user device may identify a use of AI by the entity (e.g., by the decision system) to reach the decision in connection with the user. In some implementations, the information indicating the decision may include an indication that the decision was reached using AI, and the user device may identify the use of AI based on the indication. In some implementations, the user device may identify the use of AI based on a location of the user device, a resource (e.g., a webpage, an application, or the like) that is accessed by the user device in connection with receiving the decision, and/or one or more operations (e.g., a web browsing operation, an authentication operation, a camera operation, a voice calling operation, or the like) being performed by the user device in connection with receiving the decision. For example, the user device may determine that the location of the user device (e.g., at an airport) is associated with the use of AI (e.g., facial recognition). As another example, the user device may determine that a resource that is accessed (e.g., a loan application page of a website) is associated with the use of AI (e.g., a machine learning model to determine to accept or reject the application). The user device may identify the use of AI, based on the location, the resource, and/or the operation(s), based on historical data relating to the user and/or one or more other users. For example, the historical data may be generated from one or more users reporting or logging instances when AI is being used or suspected of being used.

In some implementations, the user device may transmit a request (e.g., via an application programming interface (API)) that indicates the location, the resource, and/or the operation(s). For example, the user device may transmit the request to a device that maintains a registry (e.g., a database) of AI usage in connection with locations, resources, and/or operations (e.g., entities may register their uses of AI in the registry and/or users may register instances when AI is being used or suspected of being used in the registry). The user device may receive a response (e.g., via the API), from the device, that indicates the use of AI (e.g., the response indicates whether the entity used AI in connection with the location, the resource, and/or the operation). Accordingly, the user device may identify the use of AI based on the response.

Following the identification of the use of AI, the user device may perform operations to determine whether the decision that was reached using AI is erroneous. As shown in FIG. 1B, and by reference number 115, the user device may identify one or more historical decisions, that used AI, in connection with the user or one or more other users. The historical decisions may have been reached by the entity (e.g., the decision system) and/or one or more other entities. The historical decisions may relate to a same use case as the decision in connection with the user. The use case may be a particular scenario in which AI was used, such as a scenario involving approving or rejecting an application for services, a scenario involving a recommendation of an item, a scenario involving a recommendation of an action based on facial recognition, or the like. The historical decisions reached by the entity may indicate whether the user is receiving different treatment from other users that have interacted with the entity and/or may indicate whether the entity has changed one or more AI algorithms being used by the entity. The historical decisions reached by other entities may indicate whether the entity's use of AI is mischaracterizing the user and/or whether one or more AI algorithms being used by the entity are flawed.

The user device may identify historical decisions (e.g., relating to other users) from one or more data sources that include unstructured data indicating the historical decisions. For example, the unstructured data may include social media posts (e.g., textual posts, image posts, or video posts), message board posts, and/or blog posts, among other examples. As an example, a post may indicate whether the poster's application for services was approved or rejected (which may be a relevant historical decision if the decision in connection with the user related to the user's application for services), may indicate a user-specific price for goods or services that the poster paid (which may be a relevant historical decision if the decision in connection with the user related to a user-specific price paid by the user), or the like. In addition, a post, or metadata relating to the post, may indicate demographic information for the poster.

The user device may process the unstructured data to identify historical decisions (e.g., relating to the same use case and/or entity as the decision in connection with the user). For example, the user device may identify historical decisions by performing NLP of the unstructured data. In some examples where the unstructured data includes images and/or video, the user device may additionally or alternatively use one or more computer vision techniques to identify historical decisions. In some implementations, the user device may have a limited processing capability, and thus the processing of the unstructured data performed by the user device may be limited in scope.

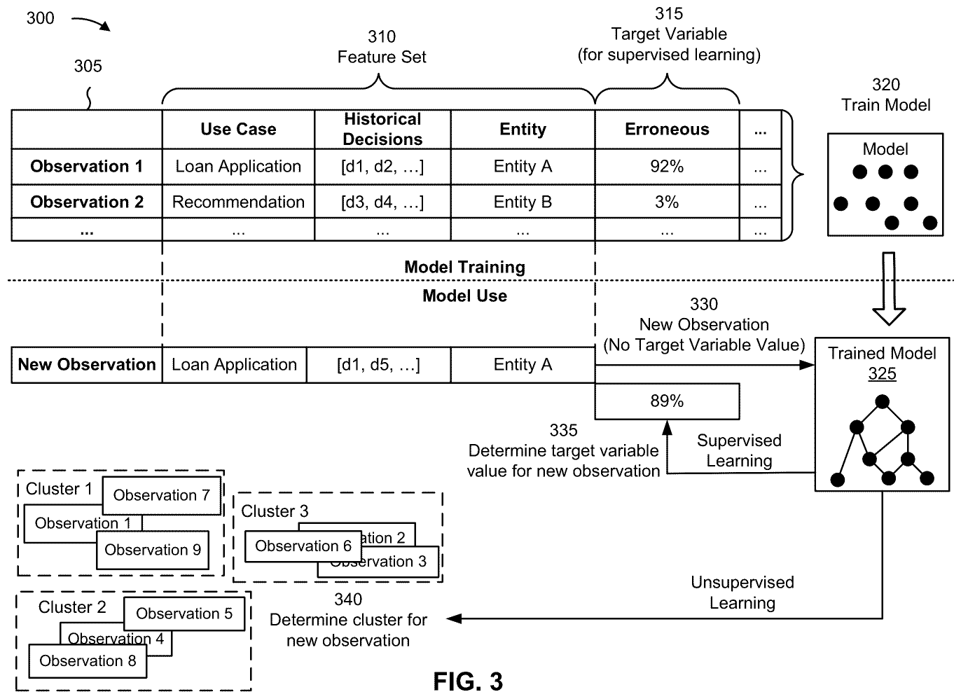

As shown in FIG. 1C, and by reference number 120, the user device may determine that the decision in connection with the user, reached using AI, is erroneous. For example, the user device may determine that the decision is erroneous using at least one machine learning model, as described further in connection with FIG. 3. In some implementations, the machine learning model may be based on an artificial neural network technique, such as a graph neural network technique. The machine learning model may be trained to determine whether the decision is erroneous based on first information relating to the use of AI by the entity and/or second information relating to the historical decisions. The first information may identify the entity (e.g., by name, by an identifier, or the like), identify a use case associated with the use of AI by the entity (e.g., by a description of the use case, by a use case identifier, by a use case category, or the like), and/or identify information (e.g., demographic information, such as an age, a gender, an education level, an occupation, or the like) relating to the user that was the subject of the use of AI by the entity.

Thus, the first information may facilitate ascertaining which of the historical decisions are most relevant to the use of AI by the entity. For example, the machine learning model may determine whether the decision is erroneous based on historical decisions associated with the same use case as the decision and in connection with other users that are similar to the user (e.g., the user and the other users are associated with similar demographic information, or the like). In other words, the machine learning model may determine whether the decision in connection with the user is erroneous based on how other similar users have been previously treated in similar situations. For example, if the decision is a rejection of the user's application for services, and if other users similar to the user had applications for services approved, then the machine learning model may determine that the decision is erroneous.

In some implementations, the machine learning model may be configured and/or trained to be biased toward determining that a use of AI is erroneous. For example, the machine learning model may be more likely to determine that a use of AI is erroneous than another machine learning model that is not configured and/or trained to be biased. In this way, the machine learning model may have greater sensitivity in determining that a use of AI is erroneous, thereby ensuring that erroneous uses of AI are detected.

As shown in FIG. 1D, and by reference number 125, the user device may provide a notification indicating that the decision in connection with the user is erroneous. In some implementations, the user device may transmit, and the reparation system may receive, a notification indicating a complaint that the decision in connection with the user is erroneous. In some implementations, the notification may cause complaint information, indicating the complaint that the decision in connection with the user is erroneous, to be added (e.g., by the reparation system) to a blockchain 135. Additionally, or alternatively, the user device may provide a notification via an output device (e.g., a display, a speaker, and/or a vibrational component, among other examples) of the user device. Here, the notification may prompt the user to report the erroneous use of AI to the reparation system and/or prompt the user to cause complaint information to be added to the blockchain 135.

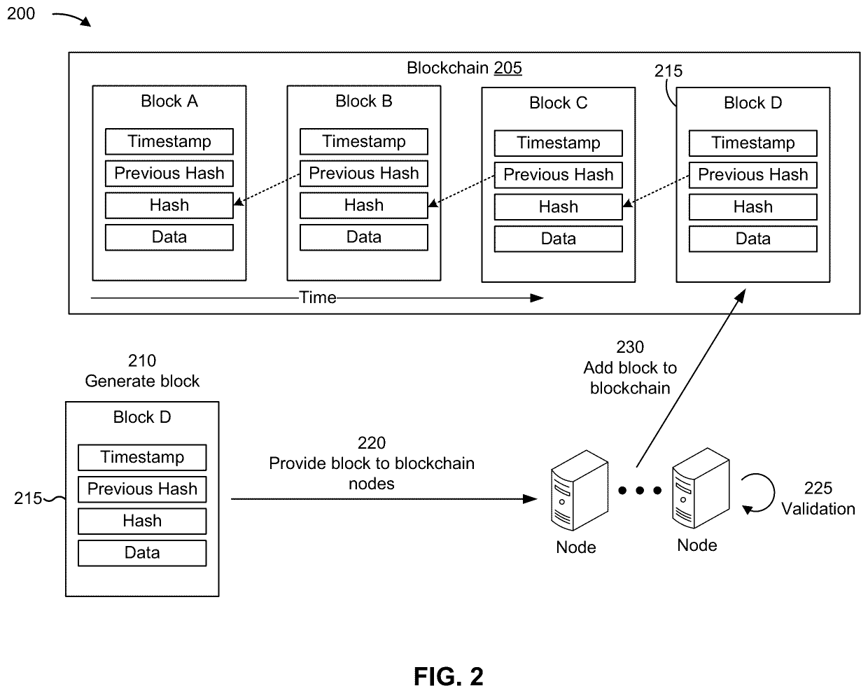

As shown by reference number 130, the user device or the reparation system may cause complaint information to be added to blockchain 135 (e.g., in Block N, as shown), as described further in connection with FIG. 2. For example, the user device may cause the complaint information to be added to blockchain 135 responsive to determining that the decision in connection with the user is erroneous. The reparation system may cause the complaint information to be added to blockchain 135 responsive to receiving the notification indicating that the decision in connection with the user is erroneous. The user device or the reparation system may cause the complaint information to be added to blockchain 135 by providing the complaint information to one or more blockchain nodes for adding to blockchain 135.

The complaint information may indicate that the decision in connection with the user is being contested (e.g., that the decision in connection with the user is believed to be erroneous). The complaint information may identify the user, the entity, the use case associated with the use of AI, a time/date associated with the use of AI, a result of the use of AI (e.g., the decision in connection with the user), and/or a non-erroneous result (e.g., a non-erroneous decision) that the use of AI should have reached, among other examples. One or more blocks of blockchain 135 (e.g., Blocks A and/or B, as shown) may include complaint information for previous complaints of erroneous AI decisions in connection with the user or other users and/or the entity or other entities. Additionally, or alternatively, one or more blocks of blockchain 135 (e.g., Blocks A and/or B, as shown) may include judgment information indicating resolutions for one or more complaints, including amounts of reparations that were awarded. Relative to another data structure, blockchain 135 may provide improved security and reliability of the complaint information and/or the judgment information, thereby enabling erroneous decisions to be detected efficiently and accurately.

As shown in FIG. 1E, and by reference number 140, the reparation system may determine whether the decision in connection with the user is erroneous and/or an amount of a reparation for the user that is to be issued by the entity. In some implementations, the reparation system may determine whether the decision is erroneous and/or the amount of the reparation responsive to receiving the notification from the user device. In some implementations, the reparation system may not receive the notification from the user device. Here, the reparation system may scan blockchain 135 to identify complaint information that is newly added to blockchain 135 (e.g., since a previous scan) and that has not been adjudicated.

The reparation system may determine whether the decision is erroneous and/or the amount of the reparation using at least one machine learning model. In a similar manner as described above, the machine learning model(s) may be trained to determine whether the decision in connection with the user is erroneous based on first information relating to the use of AI by the entity and/or second information relating to the historical decisions. The reparation system may obtain the first information from the notification and/or from the complaint information in blockchain 135.

The reparation system may identify the historical decisions from one or more data sources that include unstructured data indicating the historical decisions, in a similar manner as described above. For example, the reparation system may process the unstructured data, to identify historical decisions, by performing NLP of the unstructured data and/or using computer vision techniques, as described above. In some implementations, the data sources used by the reparation system to identify the historical decisions may include at least one different data source from the data sources used by the user device to identify the historical decisions. Moreover, the reparation system may have a superior processing capability to the user device, thereby enabling the reparation system to process more unstructured data than the user device and/or process the unstructured data using enhanced techniques relative to the user device. Accordingly, the set of historical decisions identified by the reparation system may be different from the set of historical decisions identified by the user device.

In some implementations, the machine learning model(s) used by the reparation system may be trained to determine the amount of the reparation based on historical reparation data (e.g., in judgment information) in blockchain 135. For example, the amount of the reparation for the user may be based on amounts of one or more previous reparations awarded, for the same use case, to the user and/or other users that are similar to the user (e.g., the user and the other users are associated with similar demographic information, or the like). In some implementations, the reparation system may use a first machine learning model trained to determine whether the decision is erroneous (e.g., based on the first information and the second information), and the reparation system may use a second machine learning model trained to determine the amount of the reparation (e.g., based on an output of the first machine learning model indicating that the decision is erroneous).

In contrast to the machine learning model used by the user device, the machine learning model(s) used by reparation system may not be configured and/or trained to be biased toward determining that a use of AI is erroneous. That is, the machine learning model(s) used by the reparation system may be configured and/or trained to be neutral toward determining whether a use of AI erroneous. For example, the machine learning model(s) used by the reparation system may determine whether the decision in connection with the user is erroneous based on historical decisions that are more relevant to the use case associated with the decision (e.g., compared to the historical decisions used by the machine learning model of the user device) and/or in connection with other users that are more similar to the user (e.g., compared to users used by the machine learning model of the user device). Based on this, as well as the set of historical decisions identified by the reparation system potentially being different from the set of historical decisions identified by the user device, the machine learning model(s) used by the reparation system may arrive at a different determination as to whether the decision in connection with the user is erroneous than the determination of the machine learning model used by the user device.

As shown in FIG. 1F, and by reference number 145, the reparation system may transmit, and the user device may receive, an indication of whether the reparation for the user is to be issued by the entity due to the decision in connection with the user. For example, the indication may indicate that the reparation for the user is to be issued based on the reparation system determining that the decision in connection with the user is erroneous. Additionally, the indication may indicate the amount of the reparation determined by the reparation system. The reparation system may transmit the indication in response to the notification indicating the complaint received from the user device. In some implementations, the reparation system may also transmit an indication of whether the reparation for the user is to be issued by the entity and/or the amount of the reparation to a device associated with the entity.

As shown by reference number 150, the reparation system may cause judgment information, indicating whether the decision in connection with the user is erroneous and/or the amount of the reparation to be added to blockchain 135 (e.g., in Block M, as shown). The reparation system may cause the judgment information to be added to blockchain 135 by providing the judgment information to one or more blockchain nodes for adding to blockchain 135. The judgment information may identify the complaint information (e.g., by a complaint identifier), whether the reparation is being awarded, and/or the amount of the reparation, among other examples.

In this way, the machine learning models used by the user device and the reparation system facilitate efficient detection of erroneous AI decisions. Accordingly, computing resources that may have otherwise been used attempting to understand or reverse engineer the logic used by AI in reaching a decision may be conserved. Moreover, complaint information and judgment information recorded to blockchain 135 provide data that can be used by the machine learning models to facilitate detection of erroneous AI decisions. Thus, techniques described herein continually improve an ability of the machine learning models to accurately detect erroneous AI decisions.

As indicated above, FIGS. 1A-1F are provided as an example. Other examples may differ from what is described with regard to FIGS. 1A-1F.

FIG. 2 is a diagram illustrating an example 200 of a blockchain and use thereof. As shown in FIG. 2, some operations of example 200 may be performed by multiple blockchain nodes. The blockchain nodes may form a blockchain network, and a blockchain 205 may be distributed among the blockchain nodes of the blockchain network. Blockchain 205 may be a distributed ledger, or database, that maintains a list of records, called blocks, that may be linked together to form a chain.

As shown by reference number 210, a procedure for adding to blockchain 205 may begin with generating a block 215. Block 215 may be generated in response to receiving a request (e.g., from the user device 410 and/or the reparation system 430, described herein) to add information, called a transaction, to blockchain 205. In some implementations, block 215 may be generated by a blockchain node.

As shown, each block of blockchain 205, including generated block 215, indicates a timestamp, a previous hash, a hash, and data, among other examples. For block 215, the data may include the transaction that was requested to be added. For example, the transaction may indicate complaint information or judgment information, as described herein. The transaction may be grouped, in block 215, with one or more other transactions that are awaiting publication to blockchain 205. The timestamp, the previous hash, and the hash may define a header of a block. The hash of a block may be a hash representation (e.g., using one or more hashing methods) of the block's data, and the previous hash may be the hash value in the previous block's header. For example, the previous hash in the header of Block B may be the hash value in the header of Block A, and so forth. Thus, the blocks may be chained together by each block referencing the hash value of the previous block. In this way, an altered block may be easily detected and rejected from blockchain 205.

As shown by reference number 220, generated block 215 may be provided (e.g., broadcast) to all blockchain nodes in the blockchain network. As shown by reference number 225, before block 215 is added to blockchain 205, other blockchain nodes may agree that block 215 is valid. That is, the blockchain nodes may reach a consensus on the validity of block 215. To validate block 215, the blockchain nodes may utilize one or more consensus techniques, which may utilize a proof of work (PoW) algorithm, a proof of stake (POS) algorithm, a delegated proof of stake (DPoS) algorithm, and/or a practical Byzantine fault tolerance (PBFT) algorithm, among other examples. As shown by reference number 230, once validated, the blockchain nodes may add block 215 to their respective copies of blockchain 205.

As indicated above, FIG. 2 is provided as an example. Other examples may differ from what is described in connection with FIG. 2.

FIG. 3 is a diagram illustrating an example 300 of training and using a machine learning model in connection with assessment of AI errors. The machine learning model training and usage described herein may be performed using a machine learning system. The machine learning system may include or may be included in a computing device, a server, a cloud computing environment, or the like, such as the user device 410 and/or the reparation system 430 described in more detail elsewhere herein.

As shown by reference number 305, a machine learning model may be trained using a set of observations. The set of observations may be obtained from training data (e.g., historical data), such as data gathered during one or more processes described herein. In some implementations, the machine learning system may receive the set of observations (e.g., as input) from the user device 410, the reparation system 430, and/or the blockchain node(s) 440, as described elsewhere herein.

As shown by reference number 310, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the user device 410 and/or the reparation system 430. For example, the machine learning system may identify a feature set (e.g., one or more features and/or feature values) by extracting the feature set from structured data, by performing NLP to extract the feature set from unstructured data, and/or by receiving input from an operator.

As an example, a feature set for a set of observations may include a first feature of use case, a second feature of historical decisions, a third feature of entity, and so on. As shown, for a first observation, the first feature may have a value of loan application, the second feature may have a value of d1, d2, and so forth, representing a set of historical decisions, the third feature may have a value of Entity A, and so on. These features and feature values are provided as examples, and may differ in other examples. For example, the feature set may include one or more of the following features: a use case of a decision reached in connection with a user, an entity that made the decision, a time of day of the decision, a date of the decision, a location of the decision, demographic information associated with the user (e.g., an age of the user, an education level of the user, an income of the user, and/or a profession of the user, among other examples), and/or one or more historical decisions relating to the user or other users (where one or more of the features listed above may be features for each historical decision), among other examples.

As shown by reference number 315, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 300, the target variable is whether a decision is erroneous, which has a value of 92% for the first observation.

The feature set and target variable described above are provided as examples, and other examples may differ from what is described above. For example, for a target variable of a reparation amount, the feature set may include a use case of a decision reached in connection with a user, an entity that made the decision, a monetary cost to the user resulting from the decision, a time delay to the user resulting from the decision, a physical injury to the user resulting from the decision, a value of property damage to the user resulting from the decision, and/or one or more historical reparations (where one or more of the features listed above may be features for each historical reparation), among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 320, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. For example, using a neural network algorithm, the machine learning system may train a machine learning model to output (e.g., at an output layer) an indication of whether a decision, in connection with a user, reached by an entity using AI is erroneous based on an input (e.g., at an input layer) indicating characteristics relating to the decision, the user, the entity, and/or historical decisions, as described elsewhere herein. In particular, the machine learning system, using the neural network algorithm, may train the machine learning model, using the set of observations from the training data, to derive weights for one or more nodes in the input layer, in the output layer, and/or in one or more hidden layers (e.g., between the input layer and the output layer). Nodes in the input layer may represent features of a feature set of the machine learning model, such as a first node representing use case, a second node representing historical decisions, a third node representing entity, and so forth. One or more nodes in the output layer may represent output(s) of the machine learning model, such as a first node indicating a probability that a decision is erroneous and/or a second node indicating an amount of a reparation, and so forth. The weights learned by the machine learning model facilitate transformation of the input of the machine learning model to the output of the machine learning model. After training, the machine learning system may store the machine learning model as a trained machine learning model 325 to be used to analyze new observations.

As an example, the machine learning system may obtain training data for the set of observations based on historical decision data relating to decisions reached by one or more entities using AI, complaint data indicating complaints by users alleging erroneous AI decisions, and/or judgment data indicating adjudications of the complaints (e.g., indicating whether alleged erroneous AI decisions were found to be erroneous), as described herein. The historical decision data may be obtained from unstructured data (e.g., using NLP, or the like), as described herein. The complaint data and/or the judgment data may be obtained from a blockchain, as described herein.

As shown by reference number 330, the machine learning system may apply the trained machine learning model 325 to a new observation, such as by receiving a new observation and inputting the new observation to the trained machine learning model 325. As shown, the new observation may include a first feature value of loan application, a second feature value of d1, d5, and so forth, representing a set of historical decisions, a third feature value of entity A, and so on, as an example. The machine learning system may apply the trained machine learning model 325 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 325 may predict a value of 89% for the target variable of whether a decision is erroneous for the new observation, as shown by reference number 335. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first automated action may include, for example, causing complaint information and/or judgment information to be added to a blockchain.

In some implementations, the trained machine learning model 325 may classify (e.g., cluster) the new observation in a cluster, as shown by reference number 340. The observations within a cluster may have a threshold degree of similarity. As an example, the machine learning system may classify the new observation in a first cluster (e.g., erroneous decisions), a second cluster (e.g., correct decisions), a third cluster (e.g., unsure), and so forth.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 325 may be re-trained using feedback information. For example, feedback may be provided to the machine learning model. The feedback may be associated with actions performed based on the recommendations provided by the trained machine learning model 325 and/or automated actions performed, or caused, by the trained machine learning model 325. In other words, the recommendations and/or actions output by the trained machine learning model 325 may be used as inputs to re-train the machine learning model (e.g., a feedback loop may be used to train and/or update the machine learning model). For example, the feedback information may include judgment data, as described herein.

In this way, the machine learning system may apply a rigorous and automated process to assess AI errors. The machine learning system may enable recognition and/or identification of tens, hundreds, thousands, or millions of features and/or feature values for tens, hundreds, thousands, or millions of observations, thereby increasing accuracy and consistency and reducing delay associated with assessing AI errors relative to requiring computing resources to be allocated for tens, hundreds, or thousands of operators to manually assess AI errors using the features or feature values.

As indicated above, FIG. 3 is provided as an example. Other examples may differ from what is described in connection with FIG. 3.

FIG. 4 is a diagram of an example environment 400 in which systems and/or methods described herein may be implemented. As shown in FIG. 4, environment 400 may include a user device 410, a decision system 420, a reparation system 430, one or more blockchain nodes 440, and a network 450. Devices of environment 400 may interconnect via wired connections, wireless connections, or a combination of wired and wireless connections.

The user device 410 may include one or more devices capable of receiving, generating, storing, processing, and/or providing information associated with assessment of AI errors, as described elsewhere herein. The user device 410 may include a communication device and/or a computing device. For example, the user device 410 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The decision system 420 may include one or more devices capable of receiving, generating, storing, processing, providing, and/or routing information associated with an AI decision, as described elsewhere herein. The decision system 420 may include a communication device and/or a computing device. For example, the decision system 420 may include a server, such as an application server, a client server, a web server, a database server, a host server, a proxy server, a virtual server (e.g., executing on computing hardware), or a server in a cloud computing system. In some implementations, the decision system 420 may include computing hardware used in a cloud computing environment.

The reparation system 430 may include one or more devices capable of receiving, generating, storing, processing, providing, and/or routing information associated with assessment of AI errors, as described elsewhere herein. The reparation system 430 may include a communication device and/or a computing device. For example, the reparation system 430 may include a server, such as an application server, a client server, a web server, a database server, a host server, a proxy server, a virtual server (e.g., executing on computing hardware), or a server in a cloud computing system. In some implementations, the reparation system 430 includes computing hardware used in a cloud computing environment.

The blockchain node 440 may include one or more devices capable of receiving, generating, storing, processing, providing, and/or routing information associated with a blockchain, as described elsewhere herein. The blockchain node 440 may include a communication device and/or a computing device. For example, the blockchain node 440 may include a server or a user device.

The network 450 may include one or more wired and/or wireless networks. For example, the network 450 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 450 may enable communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500 associated with assessment of AI errors using machine learning. Device 500 may correspond to user device 410, decision system 420, reparation system 430, and/or blockchain node(s) 440. In some implementations, user device 410, decision system 420, reparation system 430, and/or blockchain node(s) 440 may include one or more devices 500 and/or one or more components of device 500. As shown in FIG. 5, device 500 may include a bus 510, a processor 520, a memory 530, an input component 540, an output component 550, and a communication component 560.

Bus 510 may include one or more components that enable wired and/or wireless communication among the components of device 500. Bus 510 may couple together two or more components of FIG. 5, such as via operative coupling, communicative coupling, electronic coupling, and/or electric coupling. For example, bus 510 may include an electrical connection, a wire, a trace, a lead, and/or a wireless bus. Processor 520 may include a central processing unit, a graphics processing unit, a microprocessor, a controller, a microcontroller, a digital signal processor, a field-programmable gate array, an application-specific integrated circuit, and/or another type of processing component. Processor 520 may be implemented in hardware, firmware, or a combination of hardware and software. In some implementations, processor 520 may include one or more processors capable of being programmed to perform one or more operations or processes described elsewhere herein.

Memory 530 may include volatile and/or nonvolatile memory. For example, memory 530 may include random access memory (RAM), read only memory (ROM), a hard disk drive, and/or another type of memory (e.g., a flash memory, a magnetic memory, and/or an optical memory). Memory 530 may include internal memory (e.g., RAM, ROM, or a hard disk drive) and/or removable memory (e.g., removable via a universal serial bus connection). Memory 530 may be a non-transitory computer-readable medium. Memory 530 may store information, instructions, and/or software (e.g., one or more software applications) related to the operation of device 500. In some implementations, memory 530 may include one or more memories that are coupled (e.g., communicatively coupled) to one or more processors (e.g., processor 520), such as via bus 510. Communicative coupling between a processor 520 and a memory 530 may enable the processor 520 to read and/or process information stored in the memory 530 and/or to store information in the memory 530.

Input component 540 may enable device 500 to receive input, such as user input and/or sensed input. For example, input component 540 may include a touch screen, a keyboard, a keypad, a mouse, a button, a microphone, a switch, a sensor, a global positioning system sensor, an accelerometer, a gyroscope, and/or an actuator. Output component 550 may enable device 500 to provide output, such as via a display, a speaker, and/or a light-emitting diode. Communication component 560 may enable device 500 to communicate with other devices via a wired connection and/or a wireless connection. For example, communication component 560 may include a receiver, a transmitter, a transceiver, a modem, a network interface card, and/or an antenna.

Device 500 may perform one or more operations or processes described herein. For example, a non-transitory computer-readable medium (e.g., memory 530) may store a set of instructions (e.g., one or more instructions or code) for execution by processor 520. Processor 520 may execute the set of instructions to perform one or more operations or processes described herein. In some implementations, execution of the set of instructions, by one or more processors 520, may cause the one or more processors 520 and/or the device 500 to perform one or more operations or processes described herein. In some implementations, hardwired circuitry may be used instead of or in combination with the instructions to perform one or more operations or processes described herein. Additionally, or alternatively, processor 520 may be configured to perform one or more operations or processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

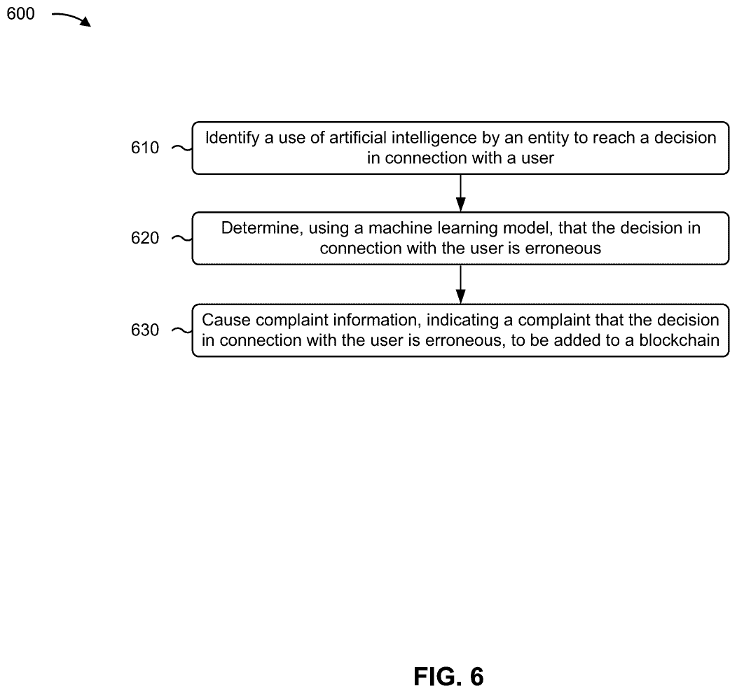

FIG. 6 is a flowchart of an example process 600 associated with assessment of artificial intelligence errors using machine learning. In some implementations, one or more process blocks of FIG. 6 may be performed by the user device 410. In some implementations, one or more process blocks of FIG. 6 may be performed by another device or a group of devices separate from or including the user device 410, such as the decision system 420, the reparation system 430, and/or one or more blockchain nodes. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include identifying a use of AI by an entity to reach a decision in connection with a user (block 610). For example, the user device 410 (e.g., using processor 520 and/or memory 530) may identify a use of AI by an entity to reach a decision in connection with a user, as described above in connection with reference number 110 of FIG. 1A. As an example, the use of AI may be identified based on a location of the user device, a resource that is accessed by the user device in connection with receiving the decision, and/or one or more operations being performed by the user device in connection with receiving the decision.

As further shown in FIG. 6, process 600 may include determining, using a machine learning model, that the decision in connection with the user is erroneous (block 620). For example, the user device 410 (e.g., using processor 520 and/or memory 530) may determine, using a machine learning model, that the decision in connection with the user is erroneous, as described above in connection with reference number 120 of FIG. 1C. As an example, the machine learning model may be trained to determine whether the decision is erroneous based on first information relating to the use of AI by the entity and second information relating to one or more historical decisions in connection with the user or one or more other users.

As further shown in FIG. 6, process 600 may include causing complaint information, indicating a complaint that the decision in connection with the user is erroneous, to be added to a blockchain (block 630). For example, the user device 410 (e.g., using processor 520, memory 530, and/or communication component 560) may cause complaint information, indicating a complaint that the decision in connection with the user is erroneous, to be added to a blockchain, as described above in connection with reference number 130 of FIG. 1D. As an example, the user device may transmit a request to a blockchain node, or another device that communicates with the blockchain node, to cause the complaint information to be added to the blockchain.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1F. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

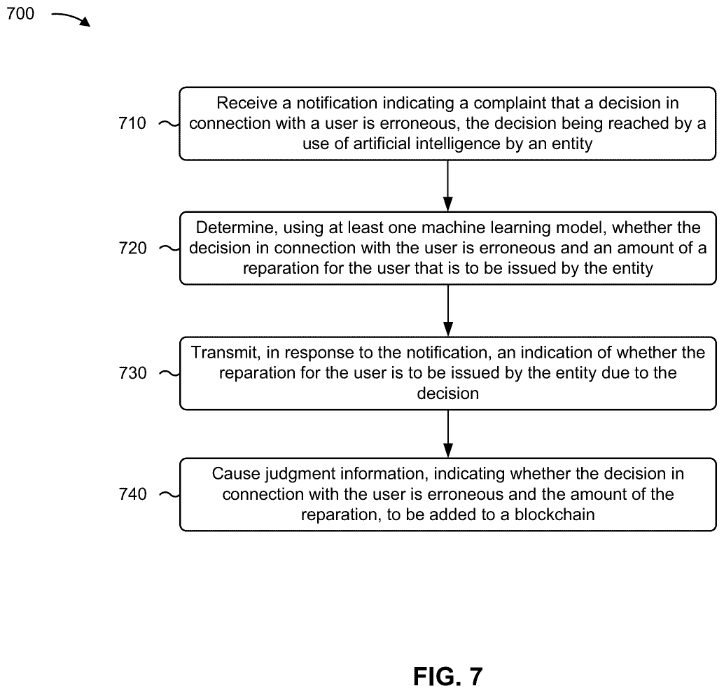

FIG. 7 is a flowchart of an example process 700 associated with assessment of artificial intelligence errors using machine learning. In some implementations, one or more process blocks of FIG. 7 may be performed by the reparation system 430. In some implementations, one or more process blocks of FIG. 7 may be performed by another device or a group of devices separate from or including the reparation system 430, such as the user device 410, the decision system 420, and/or one or more blockchain nodes 440. Additionally, or alternatively, one or more process blocks of FIG. 7 may be performed by one or more components of the device 500, such as processor 520, memory 530, input component 540, output component 550, and/or communication component 560.

As shown in FIG. 7, process 700 may include receiving a notification indicating a complaint that a decision in connection with a user is erroneous, the decision being reached by a use of AI by an entity (block 710). For example, the reparation system 430 (e.g., using processor 520, memory 530, input component 540, and/or communication component 560) may receive a notification indicating a complaint that a decision in connection with a user is erroneous, the decision being reached by a use of artificial intelligence by an entity, as described above in connection with reference number 125 of FIG. 1D. As an example, a user device of the user, based on making an initial determination that the decision is erroneous, may transmit the notification to the reparation system.

As further shown in FIG. 7, process 700 may include determining, using at least one machine learning model, whether the decision in connection with the user is erroneous and an amount of a reparation for the user that is to be issued by the entity (block 720). For example, the reparation system 430 (e.g., using processor 520 and/or memory 530) may determine, using at least one machine learning model, whether the decision in connection with the user is erroneous and an amount of a reparation for the user that is to be issued by the entity, as described above in connection with reference number 140 of FIG. 1E. As an example, the at least one machine learning model may be trained to determine whether the decision is erroneous and the amount of the reparation based on first information relating to the use of artificial intelligence by the entity and second information relating to one or more historical decisions in connection with the user or one or more other users.

As further shown in FIG. 7, process 700 may include transmitting, in response to the notification, an indication of whether the reparation for the user is to be issued by the entity due to the decision (block 730). For example, the reparation system 430 (e.g., using processor 520, memory 530, and/or communication component 560) may transmit, in response to the notification, an indication of whether the reparation for the user is to be issued by the entity due to the decision, as described above in connection with reference number 145 of FIG. 1F. As an example, based on determining that the decision is erroneous and an amount of a reparation that is to be issued to the user, the reparation system may transmit an indication, to a user device of the user, that the user's complaint was adjudicated in the user's favor and that the reparation for the user will be issued by the entity.

As further shown in FIG. 7, process 700 may include causing judgment information, indicating whether the decision in connection with the user is erroneous and the amount of the reparation, to be added to a blockchain (block 740). For example, the reparation system 430 (e.g., using processor 520, memory 530, and/or communication component 560) may cause judgment information, indicating whether the decision in connection with the user is erroneous and the amount of the reparation, to be added to a blockchain, as described above in connection with reference number 150 of FIG. 1F. As an example, the reparation system may transmit a request to a blockchain node, or another device that communicates with the blockchain node, to cause the judgment information to be added to the blockchain.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1F. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for assessment of artificial intelligence errors using machine learning, the system comprising:
one or more memories; and
one or more processors, communicatively coupled to the one or more memories, configured to:
receive a notification indicating a complaint that a decision in connection with a user is erroneous, the decision being reached by a use of artificial intelligence by an entity;
determine, using at least one machine learning model, whether the decision in connection with the user is erroneous and an amount of a reparation for the user that is to be issued by the entity,
wherein the at least one machine learning model is trained to determine whether the decision is erroneous and the amount of the reparation based on first information relating to the use of artificial intelligence by the entity and second information relating to one or more historical decisions in connection with the user or one or more other users;
transmit, in response to the notification, an indication of whether the reparation for the user is to be issued by the entity due to the decision; and
cause judgment information, indicating whether the decision in connection with the user is erroneous and the amount of the reparation, to be added to a blockchain.

2. The system of claim 1, wherein the at least one machine learning model is trained to determine the amount of the reparation based on historical reparation data in the blockchain.

3. The system of claim 1, wherein the at least one machine learning model comprises a first machine learning model trained to determine whether the decision is erroneous and a second machine learning model trained to determine the amount of the reparation.

4. The system of claim 1, wherein the first information identifies the entity and a use case associated with the use of artificial intelligence by the entity.

5. The system of claim 1, wherein the one or more historical decisions were reached by use of artificial intelligence by the entity.

6. The system of claim 1, wherein the decision and the one or more historical decisions relate to a same use case.

7. The system of claim 1, wherein the one or more processors are further configured to:
identify the one or more historical decisions relating to the one or more other users by performing natural language processing of at least one data source that includes unstructured data indicating the one or more historical decisions.

8. The system of claim 1, wherein the one or more processors are further configured to:
cause, based on the notification, complaint information, indicating the complaint that the decision in connection with the user is erroneous, to be added to the blockchain.

9. A method of assessment of artificial intelligence errors using machine learning, comprising:
identifying, by a device, a use of artificial intelligence by an entity to reach a decision in connection with a user;
determining, by the device and using a machine learning model, that the decision in connection with the user is erroneous,
wherein the machine learning model is trained to determine whether the decision is erroneous based on first information relating to the use of artificial intelligence by the entity and second information relating to one or more historical decisions in connection with the user or one or more other users; and
providing, by the device, a notification indicating that the decision in connection with the user is erroneous.

10. The method of claim 9, wherein the notification is to cause complaint information, indicating a complaint that the decision in connection with the user is erroneous, to be added to a blockchain.

11. The method of claim 9, further comprising:
transmitting a request, via an application programming interface (API), that indicates at least one of a location of the device, a resource that is accessed by the device, or one or more operations being performed by the device; and
receiving a response, via the API, that indicates the use of artificial intelligence by the entity,
wherein the use of artificial intelligence by the entity is identified based on the response.

12. The method of claim 9, further comprising:
receiving, in response to the notification, an indication of whether a reparation for the user is to be issued by the entity due to the decision.

13. The method of claim 9, wherein the first information identifies the entity and a use case associated with the use of artificial intelligence by the entity.

14. The method of claim 9, wherein the one or more historical decisions were reached by use of artificial intelligence by the entity.

15. The method of claim 9, wherein the decision and the one or more historical decisions relate to a same use case.

16. The method of claim 9, further comprising:
identifying the one or more historical decisions relating to the one or more other users by performing natural language processing of unstructured data indicating the one or more historical decisions.

17. A non-transitory computer-readable medium storing a set of instructions for assessment of artificial intelligence errors using machine learning, the set of instructions comprising:
one or more instructions that, when executed by one or more processors of a device, cause the device to:
identify a use of artificial intelligence by an entity to reach a decision in connection with a user;
determine, using a machine learning model, that the decision in connection with the user is erroneous,
wherein the machine learning model is trained to determine whether the decision is erroneous based on first information relating to the use of artificial intelligence by the entity and second information relating to one or more historical decisions in connection with the user or one or more other users; and
cause complaint information, indicating a complaint that the decision in connection with the user is erroneous, to be added to a blockchain.

18. The non-transitory computer-readable medium of claim 17, wherein the one or more instructions, that cause the device to identify the use of artificial intelligence, cause the device to:
identify the use of artificial intelligence based on at least one of a location of the device, a resource that is accessed by the device, or one or more operations being performed by the device.

19. The non-transitory computer-readable medium of claim 17, wherein the one or more instructions, when executed by the one or more processors, further cause the device to:
receive an indication of whether a reparation for the user is to be issued by the entity due to the decision.

20. The non-transitory computer-readable medium of claim 17, wherein the one or more instructions, when executed by the one or more processors, further cause the device to:
identify the one or more historical decisions relating to the one or more other users by performing natural language processing of unstructured data indicating the one or more historical decisions.
